(19) United States
(12) Patent Application Publication
(10) Pub. No.: US 2005/0144253 A1
(43) Pub. Date: Jun. 30, 2005

(54) Method and apparatus for storing and accessing on a remote server digital content obtained from a personal digital library

(76) Inventors: Hiroshi Yoshino, Edgewater, NJ (US); Keiji Shiotani, North Bergen, NJ (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/749,023

(22) Filed: Dec. 30, 2003

(51) Int. Cl. G06F 15/16

(52) U.S. Cl. 709/217; 709/247

(57) ABSTRACT

A method and apparatus is provided for storing and accessing a copy of digital content. The digital content, which is initially located on a physical medium in possession of a user, may be stored on a server for subsequent access thereon by the user. The method begins by establishing a communication link with the server. A request is provided to the server over the communication link to store a copy of the digital content on the server. A user ID is provided to the server over the communication link. The digital content from the physical medium is then uploaded to the server over the communication link. Subsequent to the step of uploading the digital content, a request is provided to the server to receive the digital content from the server. Subsequent to or simultaneous with the step of providing the request to receive the digital content, the user ID is provided to the server. The digital content from the server is received only after the user ID is provided.

### FIELD OF THE INVENTION

The present invention relates generally to the storage and transmission of digital information, and more particularly, to the storage and transmission of digital information embodied on a physical medium such as a CD or like in possession of a user.

### BACKGROUND OF THE INVENTION

Computers store, share and manipulate digital information that can be replicated accurately and shared widely among many computer systems. Computers share or receive digital information in a variety of contexts. For example, digital information can be stored, exchanged and delivered by way of magnetic (floppy diskette) or optical (CD-ROM) storage devices. Computers operating in network environments pass digital information back and forth freely and often in great volume. In fact, more and more content is being delivered in digital form, and more and more digital content is being delivered online over private and public networks, such as Intranets, the Internet and cable TV networks. Wide-spread replication and distribution of digital products support new methods of digital product manufacturing and distribution. That is, digitally stored items can be copied and distributed electronically outside the traditional methods of product manufacture and distribution.

Despite the ability to obtain digital content over computer networks, consumers nevertheless purchase and maintain growing libraries of digital content that are stored in a variety of physical media such as magnetic and optical storages devices. For example, consumers maintain libraries of digital music that are stored on CDs. Likewise, the advent of digital video players has lead to a rapid increase in the number of the digital video disks (DVDs) that consumers possess.

The need to maintain libraries of digital content is burdensome and inconvenient for a number of reasons. For instance, if a consumer wishes to listen to music in an automobile or on a portable player, the consumer must anticipate the musical content he or she will be interested in hearing and make sure to take with him or her each of the individual CDs on which that musical content is located.

Recently, a network architecture has been proposed that provides consumers with the advantages arising from ownership of CDs and DVDs with the flexibility and convenience that arises from the ability to access digital content over computer networks. These so-called content lockers serve as a central depository in which a consumer can store his or her own personal digital libraries. The consumer can then remotely access the central depository whenever a particular digital selection is desired without the need for the physical storage device on which that selection is located. The consumer with an account at a content locker service can potentially access the digital library from any appropriate device (e.g., PCs, cell phones, PDAs, and network-enabled digital audio and video players) that can connect to the locker service over a computer network such as the Internet. For example, a consumer with a portable MP3 player can download MP3 files from the locker service. A primary advantage of a locker service is that it technically enables anywhere, anytime access to the consumer's own content.

One problem with a locker service is that by itself it does not protect the copyrights of the content owners. For example, while the consumer may be provided with a license from the content owners to upload and store on a remote server a single copy of the digital content embodied on a CD, there is no assurance that other individuals will not access and download the content from the server.

### SUMMARY OF THE INVENTION

In accordance with the present invention, a method and apparatus is provided for storing and accessing a copy of digital content. The digital content, which is initially located on a physical medium in possession of a user, may be stored on a server for subsequent access thereon by the user. The method begins by establishing a communication link with the server. A request is provided to the server over the communication link to store a copy of the digital content on the server. A user ID is provided to the server over the communication link. The digital content from the physical medium is then uploaded to the server over the communication link. Subsequent to the step of uploading the digital content, a request is provided to the server to receive the digital content from the server. Subsequent to or simultaneous with the step of providing the request to receive the digital content, the user ID is provided to the server. The digital content from the server is received only after the user ID is provided.

In accordance with one aspect of the invention, the digital content is compressed prior to performing the step of uploading the digital content.

In accordance with another aspect of the invention, the digital content is received by a rendering device.

In accordance with another aspect of the invention, the rendering device is a portable digital content player.

In accordance with another aspect of the invention, the rendering device is an audio player.

In accordance with another aspect of the invention, the rendering device is an audio/visual player.

In accordance with another aspect of the invention, the rendering device is a printing apparatus.

In accordance with another aspect of the invention, the communication link is established over a computer network.

In accordance with another aspect of the invention, the computer network is the Internet.

In accordance with another aspect of the invention, the digital content is received by the rendering device over a wireless transmission link.

In accordance with another aspect of the invention, the digital content includes audio content.

In accordance with another aspect of the invention, the digital content includes video content.

In accordance with another aspect of the invention, the user ID is provided from an IC card or chip.

In accordance with another aspect of the invention, the IC chip is a non-contact IC card.

In accordance with another aspect of the invention, the user ID comprises biometric data.

In accordance with another aspect of the invention, an apparatus is provided for rendering digital content. The apparatus includes a communication interface for communicating with a remotely located server, a digital signal processor for receiving digital content from the server over the communication interface, and a data storage device for storing the received digital content. The apparatus also includes a decoder for decoding the received digital content, a digital to analog converter for converting the decoded digital content to an analog signal in which content is embodied, and a renditioning unit for rendering the content embodied in the analog signal. An input device is also provided, which receives a user ID and is operationally coupled to the communication interface for communicating the user ID to the server.

### BRIEF DESCRIPTION OF THE DRAWINGS

FIG. 1 shows one embodiment of a subscriber unit constructed in accordance with the present invention for encoding and transmitting digital content to a locker management system.

FIG. 2 is a flowchart illustrating the operation of the subscriber unit when it is used to copy and compress digital content.

FIG. 3 shows the architecture of an exemplary embodiment of the locker management system.

FIG. 4 is a flowchart showing the steps performed to upload and store data on the locker management system.

FIG. 5 shows a functional block diagram of one exemplary embodiment of a rendering device constructed in accordance with the present invention.

FIG. 6 shows an embodiment of the invention in which the digital content is initially obtained from a digital content vendor.

### DETAILED DESCRIPTION

The present invention provides a system and method by which consumers can subscribe to a service that allows them to upload and store on a remote server a single copy of the digital content embodied on a physical medium in their possession while respecting the copyrights of the content owner. In particular, this is achieved by storing a unique identifier associated with the subscriber on the server along with the digital content. The subscriber can only subsequently access and download the digital content by first providing the server with the appropriate identifier. In this way only the subscriber in possession of the original physical medium on which the digital content is located can gain access to the content. The device that is used to upload and store the digital content may or may not include a rendering device for displaying, playing or printing the content once it has been downloaded.

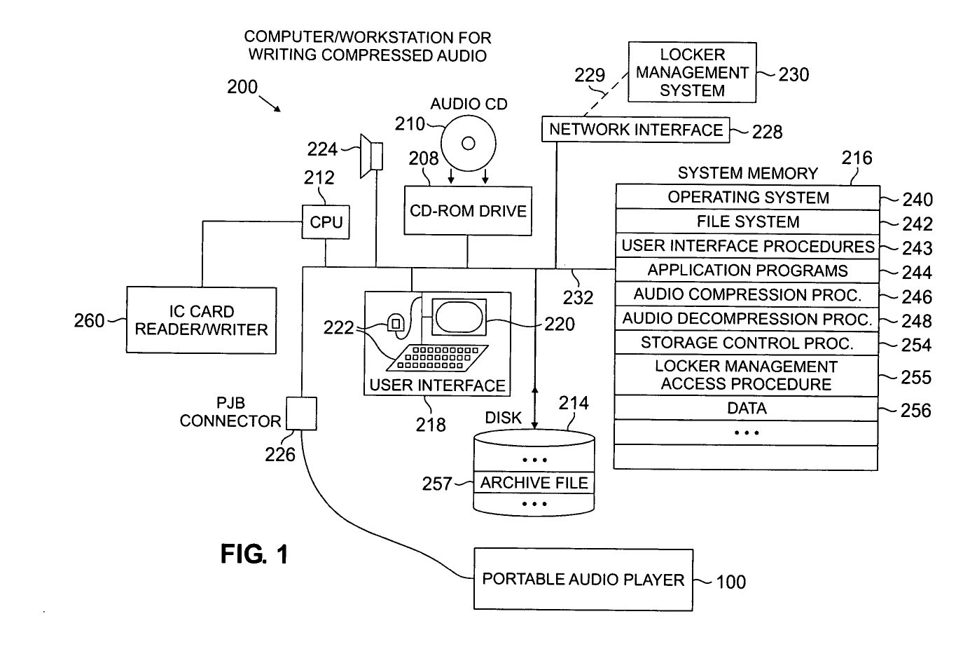

FIG. 1 shows one embodiment of a subscriber unit 200 that encodes digital content and transmits the encoded data to a locker management system 230. The subscriber unit 200 is capable of converting digital content from one format to another. For purposes of illustration only the digital content is depicted as audio information such as musical content. Accordingly, in this embodiment the subscriber unit 200 is an audio converter and recorder. Musical content is presented by way of illustration because of the current demand for such information and the widespread availability of audio compact disks. However, the digital content is not limited to audio. More generally, the digital content that is compressed and stored on locker management system 230 may be text, graphics, video, audio, and even executable applets or software files. The files that are encoded and transmitted in this manner may represent information that is currently distributed physically such as in books, magazines, newspapers, audio compact disks, DVDs, promotional multimedia, technical journals, music videos, movie trailers and complete movies. Accordingly, the subscriber unit 200 may be of any type known in the art that corresponds to the nature of the digital content being encoded.

As mentioned above, exemplary subscriber unit 200 is depicted as an audio converter. In this context the subscriber unit will convert audio content from a compact disk, which may be in an uncompressed format, for example, to a compressed format such as the MPEG audio layer 3 compression format (MP3). MP3 is able to compress CD-quality digital audio data by a factor of about ten, and thus enables a CD-quality audio signal to be delivered at a data rate of 128 kilobits per second. By making use of compression techniques, a user can thus store approximately 30 minutes of audio data in a 32 megabyte flash memory, whereas without compression, only about 3 minutes of audio data could be stored.

The subscriber unit 200 includes a CD-ROM drive 208 for receiving a CD 210 containing audio data, a data processor 212, and a system memory unit 216, preferably including both high speed random-access memory (RAM) and read-only memory (ROM), for storing system control programs, data, and application programs loaded from disk 214. The subscriber unit 200 further includes a user interface 218, including a display 220 and one or more input devices 222, one or more speakers 224 for providing audio output, and a data interface 226 for downloading compressed audio data onto a separate rendering device 100 (i.e., an audio player). A network interface 228 is provided for connecting system 200 to a computer network such as the Internet. One or more internal buses 232 interconnect the aforementioned elements of the system.

The operation of system 200 is controlled primarily by control programs that are executed by the system's data processor 212. The system's control programs may be stored in system memory 216. In a typical implementation, the programs stored in the system memory may include, an operating system 240, a file handling system 242, a set of user interface procedures 243 for handling input received from user interface 218 and displaying output to the user on display 220, one or more application programs 244, a compression procedure 246 for compressing audio data from audio CD 210, a decompression procedure 248 for decompressing compressed audio data, a storage-control procedure 254 for downloading a compressed copy of the data stored on audio CD 210 onto a decoder via data interface 226, and a locker management access procedure 255 for gaining access to the locker management system 230. In addition, system memory 216 will typically include one or more blocks of data 256, including, for example, portions of data from CD 210 that are being processed by the procedures described above.

Of course, the aforementioned control programs need not necessarily be embodied in software. Rather, the functionality performed by the control programs may be embodied in hardware or a combination of hardware and software.

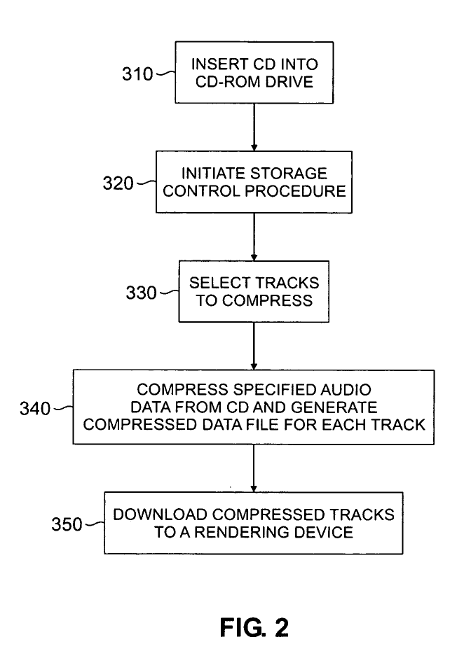

FIG. 2 is a flowchart illustrating the operation of subscriber unit 200 when it is used to copy and compress digital content. When a user inserts a CD 210 into CD-ROM drive 208 (step 310) and initiates the storage control procedure 254 (step 320), the storage control procedure obtains information regarding the CD 210 and optionally displays this information to the user. Next, the user employs input devices 222 to select the track or tracks of data located on CD 210 that the user wishes to compress (step 330). When the user's choices are received, unit 200 compresses the selected tracks using audio compression procedure 246 (step 340). As mentioned, in one embodiment, MP3 compression is used to produce CD quality compressed audio data having an associated play rate of 128 kilobits per second, although it will be recognized by one of ordinary skill in the art that any suitable compression procedure could be used. The compressed tracks may optionally also be downloaded to a rendering device 100 via data interface 226 for playback thereon.

Once the selected tracks are compressed in accordance with the aforementioned procedure, they may be transmitted via network interface 228 over communication network 229 to the locker management system 230 in the manner described below.

In accordance with the present invention, a unique identifier is transmitted to the locker management system 230 along with the compressed digital content. The unique identifier identifies the subscriber who uses the subscriber unit 200 to compress and transmit the digital content. The subscriber is presumably the owner of the physical medium (e.g., audio CD 210 in FIG. 1) in which the digital content is initially embodied. When the subscriber subsequently downloads the digital content from the locker management system, he or she will be requested to once again transmit the unique identifier before the content will be downloaded. In this way the digital content located on the locker management system can only be retrieved by the same individual (or other individuals given access to the unique identifier) who transferred the digital content to the locker management system in the first place.

In one embodiment of the invention, the unique identifier may be stored on an integrated circuit (IC) card or chip that can be read by a card or chip reader and writer. For example, returning to FIG. 1, the subscriber unit 200 includes an IC chip reader/writer 260. The unique identifier is read by the IC chip reader/writer 260 upon initiation of locker management procedure 255 when the subscriber unit 200 uploads the digital content to the locker management system 230 so that both the digital content and the unique identifier can be stored.

In one particular embodiment of the invention the IC chip and IC chip reader/writer 260 is a noncontact (wireless) data communication platform. To this end, the IC chip be an IC card has an antenna body and an integrated circuit in it. The card reader/writer supplies electrical power to the card in the form of electromagnetic energy and a DC voltage is generated within the card when information is read from or written into the card because, if the card were provided with a power supply, the maintenance thereof is troublesome and increases cost, and the power supply is an obstacle to making the card thinner. One example of a noncontact IC card and IC reader/writer is disclosed in U.S. appl. Ser. No. 10/310,371, which is hereby incorporated by reference in its entirety. Moreover, one example of a commercially available noncontact communication platform that may be employed in the present invention is the FeliCa card available from Sony Corporation. The noncontact IC chip may be a standalone element such an IC card, or it may be imbedded in other items such as a watch, pen and the like.

While the embodiment of the invention shown in FIG. 1 employs a noncontact IC chip and IC chip reader/writer, those of ordinary skill in the art will recognize that the unique identifier may be provided by any other appropriate means. For example, the identifier may be located on smart cards or magnetic stripe cards. Moreover, the unique identifier may be generated from biometric data such as fingerprints, hand geometry, facial geometry, retinal scan, voice, or any other characteristic that distinguishes one person from another. In this case IC chip reader/writer 260 may be replaced with a suitable biometric reader such as a fingerprint recognition device or the like. A unique identifier can be assigned to each unique biometric that is detected by the biometric reader.

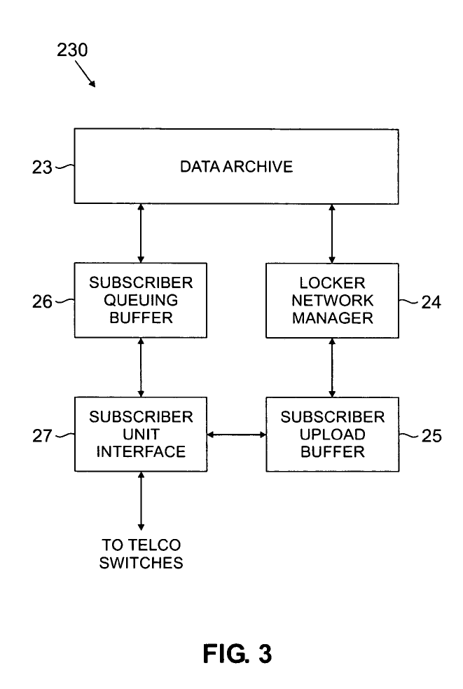

FIG. 3 shows the architecture of an exemplary embodiment of the locker management system 230. The locker management system comprises a data archive 23 that stores the compressed data files from the subscriber. A locker network manager 24 interfaces between the data archive 22 and a subscriber upload buffer 25. A subscriber queuing buffer 26 interfaces between the data archive 23 and a subscriber unit interface 27, which communicates with subscriber units such as subscriber unit 200 shown in FIG. 1. The subscriber upload buffer 25 is also coupled to the subscriber unit interface 27.

In operation, a request to upload compressed data is received from the subscriber unit via subscriber unit interface 27 and provided to the locker network manager 24. The locker network manager 24 validates the unique ID incorporated in the request from the subscriber and authorizes the data storage process to begin. In response, the subscriber upload buffer 25 accesses the data archive 23 and queues the data files from the subscriber unit 200 to the data archive 23. Likewise, when a request to download compressed data is received from the subscriber unit interface 27 it is forwarded to the locker network manager 24. The locker network manager 24 validates the unique ID incorporated in the download request and authorizes the data download process. In response, the output queuing buffer 26 accesses the data archive 22, and queues data files to the subscriber unit interface 27.

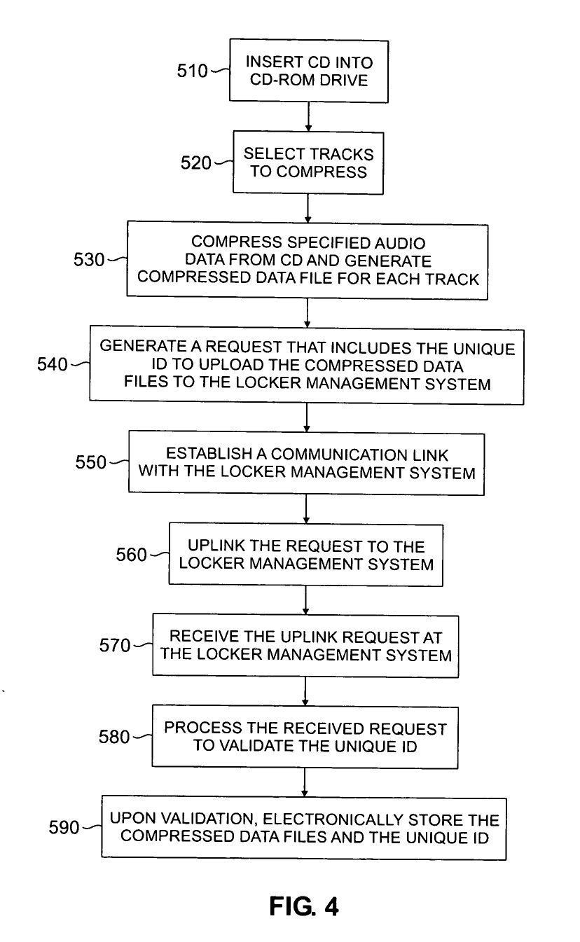

The steps performed to upload and store data on the locker management system 230 are shown in the flowchart of FIG. 4. First, in step 510, the user inserts the CD 210 into the CD-ROM drive 208 of subscriber unit 200 and, in step 520, selects the track or tracks to be compressed. The subscriber unit then compresses the specified audio data from CD 210 in step 530 and generates a compressed data file for each track. Next, in step 540 the locker management access procedure 255 is activated to generate a request to upload the compressed data files to the locker management system. Included in the request is the unique ID provided from the IC chip via IC chip reader/writer 260. Network interface 228 establishes a communication link with the locker management system 230 in step 550 and uplinks the request to the locker management system 230 in step 560. The locker management system 230 receives the uplink request in step 570 and processes the received request in step 580 to validate the unique ID. Upon validation, the compressed data files and the unique ID are electronically stored in the locker management system 230 in step 590.

Once the compressed data has been stored on the locker management system 230 it may be subsequently downloaded to any appropriate rendering device on which the data can accessed in an appropriate manner. For instance, continuing with the example set forth above in which audio data in an MP3 format is stored on the locker management system 230, the data can be subsequently downloaded to a portable MP3 player that is equipped with an ID chip reader/writer and a suitable interface for communicating the unique ID and the compressed data between the portable MP3 player and the locker management system 230. Of course, depending on the nature of the digital content, the rendering device may be any other suitable device such as a DVD or video player (for audio-visual content) or a printing apparatus (for text and graphics based content). Of course, the rendering device may even be incorporated into subscriber unit 200.

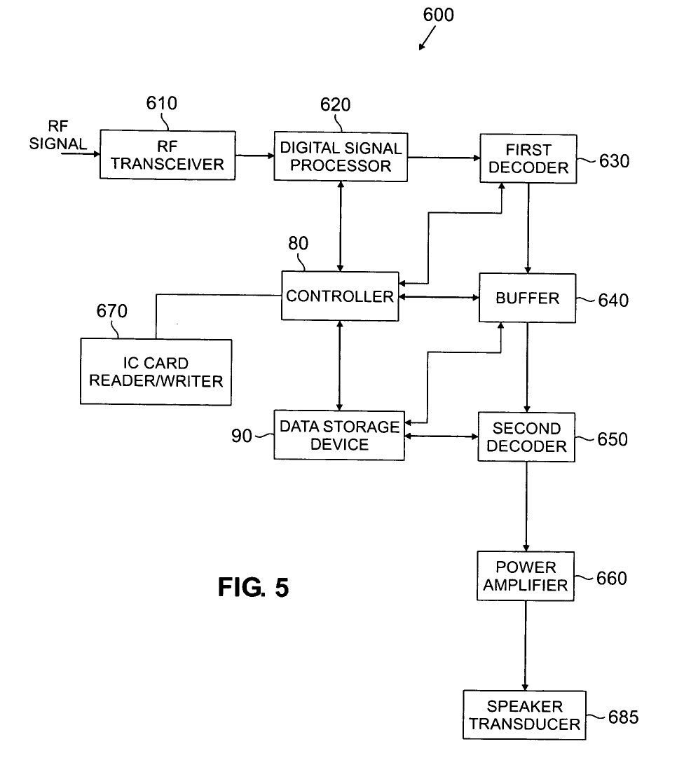

FIG. 5 shows a functional block diagram of one exemplary embodiment of a rendering device constructed in accordance with the present invention, which in this example is an MP3 player. In this embodiment the rendering device directly receives the digital content from the locker management system 230. Of course, as shown in FIG. 1 the rendering device may alternatively receive the digital content from the subscriber unit 200, which in turn has received it from the locker management system 230.

Referring now to FIG. 5, the MP3 player 600 has an RF transceiver 610 for transmitting the request to download the compressed data from the locker management system 230 to the MP3 player 600 and for receiving the compressed data from the locker management system 230. The player 600 also includes a digital signal processor 320 for signal-processing the RF signal received by the RF transceiver 610 to extract the compressed audio signal from the carrier in a known manner. A first decoder 630 is provided for correcting errors in the compressed audio data extracted from the digital signal processor 620. A buffer 640 stores the error-corrected audio data from the first decoder 630 for a predetermined time. The error corrected, compressed audio signal also may be stored in a data storage device 690 for subsequent playback. Data storage device 390 may be a magnetic hard disk, optical storage unit, memory stick, flash memory card, or other non-volatile memory. A second decoder 650 reads the error-corrected audio data from the temporary memory 640 or from the data storage device 390 and uncompresses the data. An audio converter 660 converts the uncompressed digital audio signal received from the second decoder 650 into an analog audio signal. An amplifier 660 amplifies the analog audio signal to drive a speaker transducer 685 that generates the audio for the listener. The aforementioned components all operate under the direction and control of a controller 680. An IC chip reader/writer 670 or other suitable device is provided for transmitting a unique user ID to the controller 680, which in turn uploads the user ID to the locker management system 230 when the subscriber initiates a procedure to download digital content that has been previously stored on locker management system 230.

In some embodiments of the invention RF transceiver 610 of MP3 player 600 employs a communication standard, preferably a broadcastable wireless protocol, such as Bluetooth, IEEE 802.11, IEEE 802.15, IEEE802.16, Near Field Communication—Interface and Protocol (“NFCIP-1”), and HomeRF. In these embodiments the RF transceiver 610 communicates with a network interface (not shown in FIG. 7) that in turn can communicate with the locker management system 230. Of course, other wireless protocols can be implemented, which may operate at a variety of different communication frequencies. Moreover, while in FIG. 5 the RF transceiver 610 communicates over a wireless link, those of ordinary skill in the art will recognize that the wireless transceiver 610 may be replaced with an interface that connects to the network interface via a cable that connects to a Universal Synchronous Bus (USB) port or parallel port of the network interface. In other embodiments of the invention the RF transceiver 610 may be simply replaced with a direct interface (e.g., a cable modem) to the computer network over which the locker management system 230 communicates.

In some embodiments of the invention that employ an IC chip the rendering device may be provided with an extra measure of security to ensure that copyrights are not circumvented. Such a situation could arise, for example, if the legitimate subscriber in possession of the IC chip uses the chip to download and render digital content, e.g., a movie, to a rendering device, e.g., a DVD player, for the benefit of a third party. In this case the legitimate subscriber could simply insert the chip at the beginning of the downloading and rendering process and then depart from the vicinity, effectively allowing the third party to illegitimately experience the digital content. This problem can be avoided by configuring the IC chip reader/writer so that it only downloads and renders a small segment of content before requiring reauthentication from the IC chip. For example, if a movie is being played, only a short segment of the movie (e.g., 5 seconds to 1 minute) will be downloaded. The next segment of the movie will only be downloaded if the unique ID is once again provided by the IC chip to the locker management system. Accordingly, in order to view the entire movie without interruption the subscriber will in effect be required to leave the IC chip in the IC chip reader/writer for the duration of the movie.

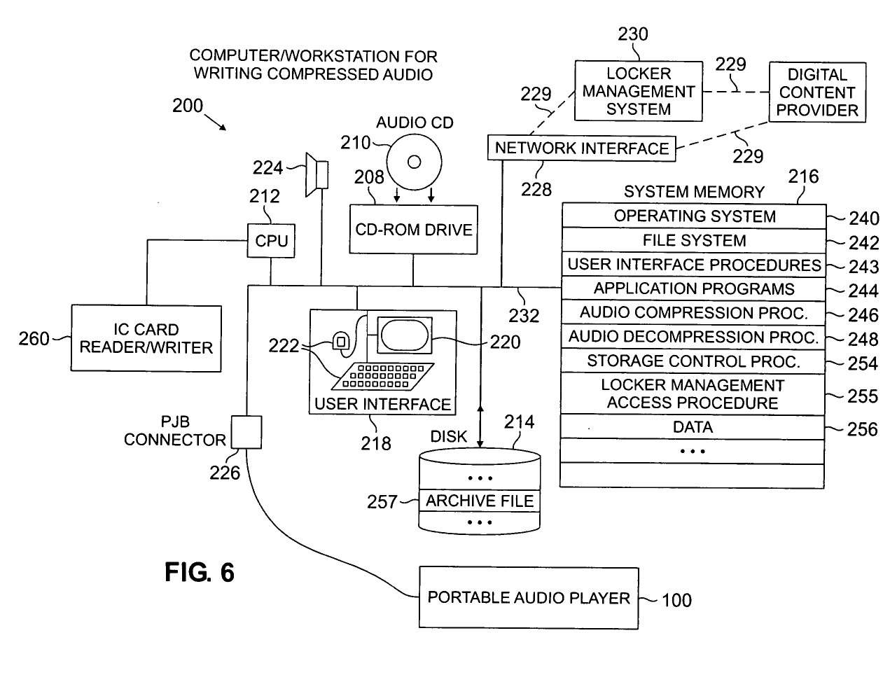

In the previously discussed embodiments of the invention it was assumed that the subscriber was in possession of the physical medium on which the digital content is located. However, in other embodiments of the invention the subscriber may not be in possession of the physical medium, but must rather first purchase it from a vendor such as a music retailer, for example. FIG. 6 shows a schematic functional block diagram of such an embodiment.

FIG. 6 is similar to the embodiment of the invention depicted in FIG. 1 except that FIG. 6 also shows a digital content vendor 270, which may be an on-line retailer of digital content. For example, if the digital content is music, the on-line retailer may be a vendor such as Amazon.com, CDnow, HMV Records and the like. In this case the subscriber first purchases the digital content from the content vendor 270 over the communication network 229 using well-established on-line transaction procedures. However, in the present invention the content vendor 270 gives the subscriber the option of having the digital content that is purchased downloaded directly from the vendor 270 to the locker management system 230. If the subscriber selects this option, the subscriber forwards his or her unique ID to the content vendor 270 in the manner previously described in connection with FIG. 4. The vendor 270 then downloads the digital content, compressed or uncompressed, to the locker management system 230 along with the subscriber's unique ID. The subscriber can subsequently access the digital content directly from the locker management system 230 by providing the unique ID as previously discussed. In addition to storing the purchased content on the locker management system 230, the content vendor 270 may also give the subscriber the option of purchasing the digital content on a physical medium, possibly at additional cost.

The embodiment of the invention discussed in connection with FIG. 6 may also be employed when the subscriber is in possession of the physical medium, but the digital content located on the physical medium is copy-protected to prevent the subscriber from making additional copies of the content. For example, some copy-protected arrangements provide each physical medium (e.g., CD) with a number that uniquely identifies that particular physical embodiment of the digital content. In this case the vendor 270 can provide the digital content directly to the locker management system 230 as shown in FIG. 6. However, the vendor 270 will only download the digital content in this manner after it confirms that the subscriber is in possession of the physical medium by first checking the medium's unique number, which the subscriber provides to the vendor 270.

1. A method of storing and accessing a copy of digital content located on a physical medium in possession of a user on a server for subsequent access thereon by the user, said method comprising the steps of:
a. establishing a communication link with the server;
b. providing to the server over the communication link a request to store a copy of the digital content on the server;
c. providing to the server over the communication link a user ID;
d. uploading the digital content from the physical medium to the server over the communication link;
e. subsequent to the step of uploading the digital content, providing a request to the server to receive the digital content from the server;
f. subsequent to or simultaneous with the step of providing the request to receive the digital content, providing to the server the user ID; and
g. receiving the digital content from the server only after performing step (f).

2. The method of claim 1 further comprising the step of compressing the digital content prior to performing the step of uploading the digital content.

3. The method of claim 1 wherein the digital content is received by a rendering device.

4. The method of claim 3 wherein said rendering device is a portable digital content player.

5. The method of claim 3 wherein said rendering device is an audio player.

6. The method of claim 3 wherein said rendering device is an audio/visual player.

7. The method of claim 3 wherein said rendering device is a printing apparatus.

8. The method of claim 1 wherein the communication link is established over a computer network.

9. The method of claim 8 wherein the computer network is the Internet.

10. The method of claim 3 wherein the digital content is received by the rendering device over a wireless transmission link.

11. The method of claim 1 wherein the digital content includes audio content.

12. The method of claim 1 wherein the digital content includes video content.

13. The method of claim 1 wherein the user ID provided in step (c) is provided from an IC chip.

14. The method of claim 1 wherein the user ID provided in step (f) is provided from an IC chip.

15. The method of claim 13 wherein said IC chip is a non-contact IC card.

16. The method of claim 14 wherein said IC chip is a non-contact IC card.

17. The method of claim 1 wherein the user ID comprises biometric data.

18. The method of claim 1 wherein the step of receiving digital content comprises the step of receiving only a segment of the digital content and further comprising the step of providing to the server the user ID in order to receive a subsequent segment of the digital content.

19. The method of claim 14 wherein the step of receiving digital content comprises the step of receiving only a segment of the digital content and further comprising the step of providing to the server the user ID in order to receive a subsequent segment of the digital content.

20. An apparatus for rendering digital content, comprising:
a communication interface for communicating with a remotely located server;
a digital signal processor for receiving digital content from the server over the communication interface;
a data storage device for storing the received digital content;
a decoder for decoding the received digital content;
a digital to analog converter for converting the decoded digital content to an analog signal in which content is embodied;
a renditioning unit for rendering the content embodied in the analog signal; and
an input device for receiving a user ID, said input device being operationally coupled to the communication interface for communicating said user ID to the server.

21. The apparatus of claim 20 wherein said digital content is audio information and said renditioning unit is a speaker transducer.

22. The apparatus of claim 20 wherein said digital content includes visual information and said renditioning unit includes a display.

23. The apparatus of claim 20 wherein said digital content includes text or graphical based information and said renditioning unit includes a printer.

24. The apparatus of claim 20 wherein said input device is an IC chip reader/writer.

25. The apparatus of claim 24 wherein said IC chip reader/writer is a non-contact IC chip reader/writer.

26. The apparatus of claim 20 wherein said communication interface is an RF transceiver.

27. The apparatus of claim 20 wherein said RF transceiver employs a wireless protocol selected from the group consisting of Bluetooth, IEEE 802.11, IEEE 802.15, IEEE 802.16, Near Field Communication—Interface and Protocol (“NFCIP-1”), and HomeRF.

28. The apparatus of claim 20 wherein said communication interface is a cable modem.

29. A method of storing and downloading a compressed copy of digital content to a subscriber in possession of a physical medium on which an uncompressed copy of the digital content is located, said method comprising the steps of:
a. receiving a request to store a copy of digital content from the subscriber over a communication link;
b. receiving over the communication link a subscriber ID;
c. receiving over the communication link a compressed copy of the digital content from the physical medium in the possession of the subscriber;
d. subsequent to the step of receiving the compressed copy of the digital content, receiving a request to download the digital content to the subscriber;
e. subsequent to or simultaneous with the step of receiving the request to receive the digital content, receiving the subscriber ID; and
f. providing the compressed copy of the digital content to the subscriber over the communication link.

30. A method of acquiring digital content from a content provider, said method comprising the steps of:
a. establishing a communication link with the content provider;
b. providing to the content provider over the communication link a request to acquire digital content from the content provider by transferring the digital content from the content provider to a remotely located server;
c. providing to the content provider over the communication link a user ID;
d. subsequent to the step of uploading the digital content, providing a request over a communication link to the server to receive the digital content from the server;
e. subsequent to or simultaneous with the step of providing the request to receive the digital content, providing to the server the user ID; and
f. receiving the digital content from the server only after performing step (e).
